(19) United States
(12) Patent Application Publication
(10) Pub. No.: US 2021/0170985 A1
(43) Pub. Date: Jun. 10, 2021

(54) Self-Tensioning and Retracting Pet Safety Belt Device

(71) Applicant: Reid Anderson, Oshawa (CA)

(72) Inventor: Reid Anderson, Oshawa (CA)

(21) Appl. No.: 17/105,590

(22) Filed: Nov. 26, 2020

Related U.S. Application Data
(60) Provisional application No. 62/945,543, filed on Dec. 9, 2019.

(51) Int. Cl. B60R 22/10; B60R 22/34; A01K 1/06

(52) U.S. Cl. CPC B60R 22/10; A01K 1/0613; B60R 22/34

(57) ABSTRACT

A self-tensioning and retracting pet safety belt device is disclosed herein. The device permits a dog or other pet to move freely within a vehicle while securing the pet in the event of a collision or other rapid change in acceleration. Dogs, especially, enjoy riding in a vehicle with their head sticking out a window, and the length of belt required to allow this activity while securing the dog to the vehicle is too long to prevent the dog from being thrown around in the event of a collision. A shorter belt, on the other hand, would increase the safety of the pet in a collision but would not allow the dog as much movement as it would desire. A self-tensioning and retracting pet safety belt device appropriately increases the pet's safety while also allowing it as much freedom of movement as desired.

### FIELD OF THE INVENTION

The present invention relates in general to safety devices, and, more specifically, to a self-tensioning and retracting pet safety belt device.

### BACKGROUND OF THE INVENTION

There are several disadvantages among safety devices found in the prior art.

A seat belt, which may also be known as a safety belt, is an automobile safety device meant to secure a passenger to a vehicle to reduce the likelihood of severe injury in the event of a collision. Such belts help to secure passengers into a vehicle to prevent their being ejected from the vehicle or their being thrown around inside the vehicle as a result of the change in vehicle speed. Seat belts also help to reduce the negative effects of secondary impacts, which occur when a vehicle passenger strikes an item in the vehicle, by keeping the passenger correctly positioned for their airbags to be used effectively.

Seat belts are made in a variety of styles based on their intended use. Slower vehicles or those used in public transportation may only use a 2-point seatbelt, which is a belt attached at either end to the vehicle and which is looped over the passenger. Standard vehicle seatbelts generally comprise a 3-point design, which may be attached at a high point and a low point on one side of the passenger, and a middle point on the other side of the passenger, to cover both the upper and lower torso of the passenger. Faster moving vehicles and race cars tend to use 5 or 6-point safety belts, which attach to the vehicle at 5 or 6 points around the passenger to fully restrict their movement relative to the vehicle.

Central to the function of seat belts is the locking retractor mechanism, which provides the passenger some ability to extend the seat belt while locking the belt during hard deceleration. One common type of retractor implements a centrifugal clutch mechanism, which locks the seat belt when the belt is pulled too quickly from the reel and only allows the belt to be pulled slowly from the reel. A second type of retractor implements a pendulum lock mechanism, which causes the reel to lock when the pendulum is swung too far from its plumb position by rapid deceleration.

Many vehicle users who are also pet owners, especially dog owners, enjoy taking their dog or other pet with them in the vehicle. An unsecured dog in a vehicle collision is just as susceptible as a human passenger to injury as a result of secondary impacts, so methods for securing pets into the vehicle have been devised. The problem lies, though, in the fact that dogs tend to move around within the vehicle while it is in motion.

One solution for securing a dog to a vehicle involves a static belt that limits the dog's range of motion, keeping them within the vehicle and restricting the distance they might travel in a collision. The problem with such a solution is that the dog is not able to move around within the vehicle and cannot stick its head out of the window, as dogs are known to enjoy doing. Another solution might include attaching two such static belts together, using a longer belt that allows the dog to move more freely, or using an elastic belt that allows the dog to stick its head out of the window. The problem with all such solutions is that the dog is allowed to be thrown much further in a vehicle collision, canceling the wanted safety effect of the device.

Thus, there is a need in the art for a pet safety belt device that can permit a dog or other pet to move freely within the vehicle while also securing the dog or other pet in the event of a collision or other rapid change in acceleration. It is to these ends that the present invention has been developed.

### SUMMARY OF THE INVENTION

To minimize the limitations in the prior art, and to minimize other limitations that will be apparent upon reading and understanding the present specification, the present invention describes a self-tensioning and retracting pet safety belt device and its method of operation.

According to an embodiment, there is a self-tensioning and retracting pet safety belt device that may comprise a seat belt.

According to an embodiment, there is a self-tensioning and retracting pet safety belt device that may comprise a vehicle add-on.

According to an embodiment, there is a self-tensioning and retracting pet safety belt device that may comprise a tensioner.

According to an embodiment, there is a self-tensioning and retracting pet safety belt device that may comprise a retractor.

According to an embodiment, there is a self-tensioning and retracting pet safety belt device that may comprise an anchoring element, like a vehicle adapter.

According to an embodiment, there is a self-tensioning and retracting pet safety belt device that may comprise a fastener, like a collar adapter.

According to an embodiment, there is a self-tensioning and retracting pet safety belt device that may comprise a resilient material of construction.

According to an embodiment, there is a self-tensioning and retracting pet safety belt device that may comprise an antimicrobial material of construction.

According to an embodiment, there is a method for securing a load using a self-tensioning and retracting pet safety belt device that may comprise attaching a fastener to a load and configuring the anchoring element such that the load cannot move away from the anchoring element to a distance greater than the length of the belt.

According to an embodiment, there is a method for securing a load using a self-tensioning and retracting pet safety belt device that may comprise configuring a retractor to apply a force to wind a belt on a reel, with said force being adjustable to complement a load.

According to an embodiment, there is a method for securing a load using a self-tensioning and retracting pet safety belt device that may comprise configuring a tensioner to lock a reel to fix an extended length of belt, possibly in response to a trigger.

These and other advantages and features of the present invention are described herein with specificity so as to make the present invention understandable to one of ordinary skill in the art, both with respect to how to practice the present invention and how to make the present invention.

Other aspects and features according to the present application will become apparent to those ordinarily skilled in the art upon review of the following description of embodiments of the invention in conjunction with the accompanying figures.

### BRIEF DESCRIPTION OF THE FIGURES

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

The principles of the invention may better be understood with reference to the accompanying figures provided by way of illustration of an exemplary embodiment, or embodiments, incorporating principles and aspects of the present invention, and in which:

FIG. 1 illustrates a front elevation view of a self-tensioning and retracting pet safety belt device, as contemplated by the present disclosure;

FIG. 2 illustrates a rear elevation view of a self-tensioning and retracting pet safety belt device, as contemplated by the present disclosure;

FIG. 3 illustrates a lateral cross-sectional view of a self-tensioning and retracting pet safety belt device, as contemplated by the present disclosure; and

FIG. 4 illustrates a front elevation view of a self-tensioning and retracting pet safety belt device showing additional interior detail, as contemplated by the present disclosure.

### DETAILED DESCRIPTION OF EMBODIMENTS OF THE INVENTION

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and in some instances proportions may have been exaggerated in order to more clearly to depict certain features of the invention.

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

According to an embodiment of the invention, there is a safety device comprising a belt, a tensioner, a retractor, a reel, a fastener, and an anchoring element wherein the fastener is at a first end of the belt and the anchoring element is at a second end of the belt and wherein the fastener is attached to secure a load.

According to embodiments of the invention, there may be protective housing containing the reel, a protective shroud, a protective coating, a protective lining, a protective insulator, or an adaptor that creates a rotating or articulating connection between the belt and the anchoring element or the fastener. The tensioner may use a centrifugal clutch or pendulum lock mechanism while the retractor may use a spring retractor mechanism. The fastener may be a clip, hook, or button loop and the anchoring element may attach to part of a vehicle, like a vehicle seat belt receiver. The load may be an animal, like a dog or a cat, and the fastener may attach to a collar, harness, jacket, sweater, or other article of clothing or accessory affixed to the animal. The retractor may apply a constant force to wind the belt on the reel and the tensioner may lock the reel to fix an extended length of the belt. The belt, the tensioner, the retractor, the reel, the fastener, or the anchoring element may be comprised of polyester, nylon, plastic, acrylic, polycarbonate, steel, aluminum, brass, copper, silver, gold, fiberglass, carbon fiber, or any combination thereof or of material with antibacterial, biocidal, microbiocidal, antifungal, antiviral, or other antimicrobial or antipathogenic properties.

According to embodiments of the invention, there is a method for securing a load using a belt, a tensioner, a retractor, a reel, a fastener, and an anchoring element, wherein the fastener is at a first end of the belt and the anchoring element is at a second end of the belt, comprising the steps of attaching the fastener to the load and configuring the anchoring element such that the load cannot move away from the anchoring element to a distance greater than the length of the belt.

According to embodiments of the invention, the retractor may be configured to apply a force to wind the belt on the reel and this force may be adjusted to be stronger or weaker depending on the intended load. The tensioner may be configured to lock the reel to fix an extended length of the belt and may also be configured to lock the reel in response to a trigger.

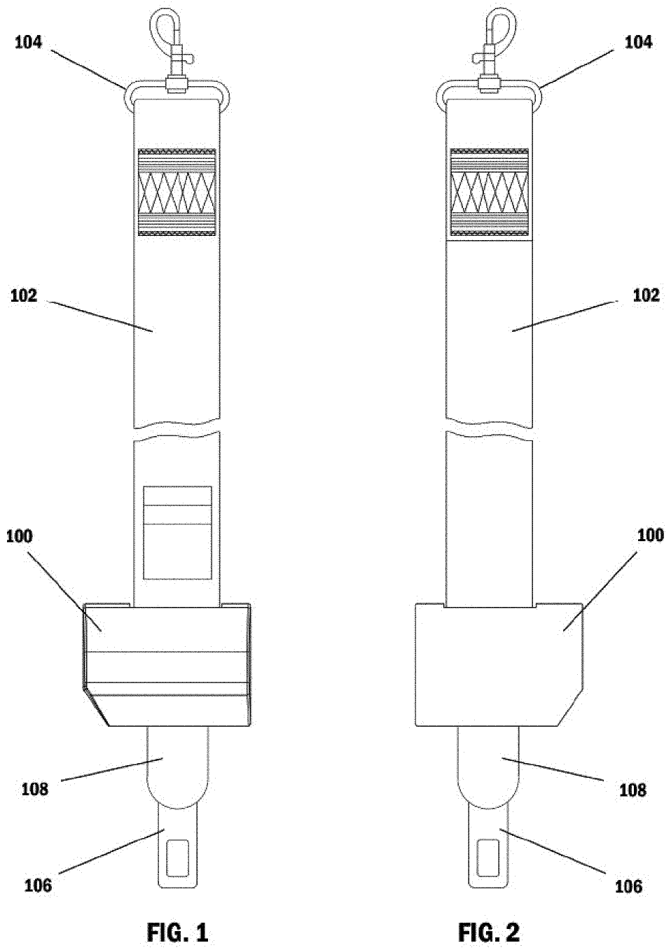

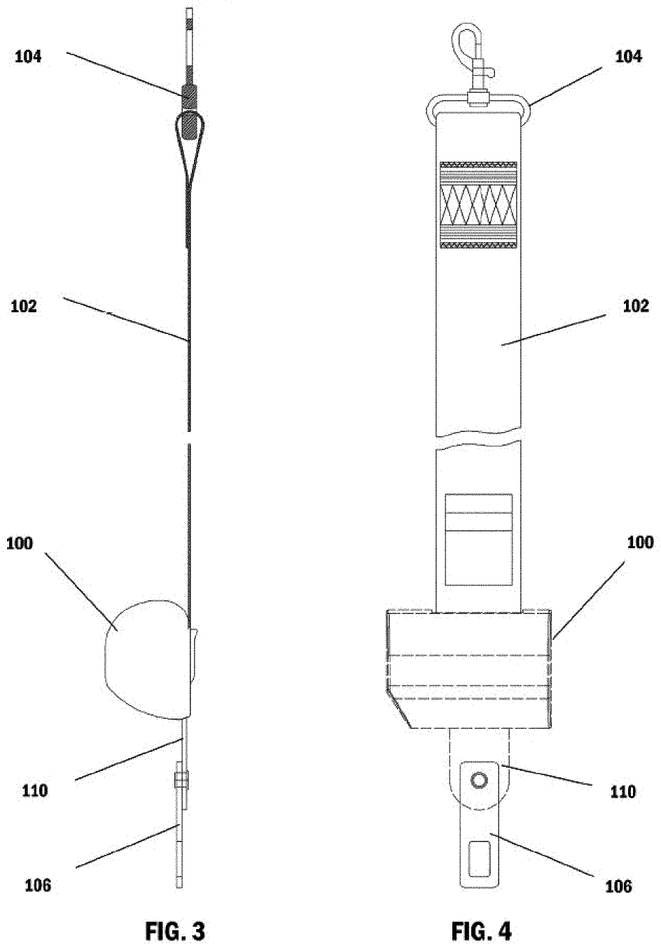

The embodiments illustrated in FIGS. 1 to 4 illustrate a self-tensioning and retracting pet safety belt device, as contemplated by the present disclosure. In one embodiment the device can permit a dog or other pet to move freely within a vehicle while also securing the dog or other pet in the event of a collision or other rapid change in acceleration. Dogs, especially, enjoy riding in a vehicle with their head sticking out a window, and the length of belt required to allow this activity while securing the dog to the vehicle is too long to prevent the dog from being thrown around in the event of a collision. A shorter belt, on the other hand, would increase the safety of the pet in a collision but would not allow the dog as much movement as it would desire. A self-tensioning and retracting pet safety belt device would appropriately increase the pet's safety while also allowing it as much freedom of movement as desired.

The self-tensioning and retracting pet safety belt device may comprise, generally, a housing 100 enclosing a seat belt 102 on a reel containing a self-tensioning and retracting mechanism. The self-tensioning mechanism may be any appropriate mechanism such as, for example, a centrifugal clutch mechanism or a pendulum lock mechanism. The retracting mechanism may be any appropriate mechanism such as, for example, a spring retractor mechanism. The seat belt 102 may be any appropriate belt such as, for example, polyester and nylon seat belt webbing.

In one embodiment the seat belt 102 may be attached at a proximal end to a reel contained within the housing 100, and may be wound around the reel within the housing 100. The self-tensioning mechanism and retracting mechanisms may be incorporated into or attached to the reel and may also be contained within the housing 100. The housing 100 may further comprise an opening, which may itself comprise a slit or slot large enough for the belt to pass through, that may allow the seat belt 102 to exit the housing 100.

At a distal end the seat belt 102, after exiting the housing 100, may be inserted into a collar adapter 104 and then sewn back into itself so as to create a loop securing the seat belt 102 to the collar adapter 104 and to prevent the seat belt 102 from retracting completely into the housing 100. The collar adapter 104 may be any appropriate adapter such as, for example, a clip, hook, button loop, or other adapter suitable for connecting the seat belt 104 to a pet collar.

The self-tensioning and retracting pet safety belt device may further comprise a vehicle adapter 106, which may be attached to the housing 100 on an opposite side from the exit of the seat belt 102. The vehicle adapter 106 may be any adapter suitable for plugging into a standard vehicle seat belt receiver. The vehicle adapter 106 may, further, be connected to the housing 100 via an adapter connector 110, which may be a secondary adapter attached to the vehicle adapter 106 via a rotating or articulating connection. In this way the housing 100 may rotate or articulate relative to the vehicle seat belt receiver to allow for a larger range of motion of the device.

The self-tensioning and retracting pet safety belt device may further comprise a protective shroud 108, which may be installed over the vehicle adapter 106 or the adapter connector 110. The protective shroud 108 may comprise any shroud appropriate for protecting the components enclosed from damage and contamination so as to prevent gumming of the mechanism for allowing the device to maintain its range of motion over time. The protective shroud 108 may further reduce the likelihood of injury to a user of the device by covering moving parts of the device and preventing pinching.

To begin using the self-tensioning and retracting pet safety belt device a user may first insert the vehicle adapter 106 into a vehicle seat belt receiver in their vehicle as they would a standard seat belt. The user may then connect the collar adapter 104 to a collar being worn by a pet within the vehicle as they would a standard leash. The pet may then move around within the vehicle and the seat belt 102 may be unwound from the housing 100 as needed. As the pet moves closer to the housing 100 the retracting mechanism of the device may shorten the exposed length of the seat belt 102. In the event of a sudden or rapid deceleration of the vehicle the self-tensioning mechanism may activate to prevent the pet from being thrown forward within the vehicle.

The self-tensioning and retracting pet safety belt device may be substantially constructed of any suitable material or combination of materials, but typically is constructed of a resilient material or combination of materials such that the device is resistant to damage as a result of compression, twisting, heating, or submersion in water. As an example, and without limiting the scope of the present invention, various exemplary embodiments of the self-tensioning and retracting pet safety belt device may be substantially constructed of one or more materials of plastic, acrylic, polycarbonate, steel, aluminum, brass, fiberglass, carbon fiber, or combinations thereof. In some embodiments the various components of the system may be coated, lined, or otherwise insulated to prevent contamination. In one embodiment the material of construction may vary from one component to the next within the system.

In one embodiment the self-tensioning and retracting pet safety belt device may comprise a resilient material of construction that either comprises a material having antimicrobial properties or comprises a layering of antimicrobial material or coating. Antimicrobial properties comprise the characteristic of being antibacterial, biocidal, microbicidal, anti-fungal, anti-viral, or other similar characteristics, and the oligodynamic effect, which is possessed by copper, brass, silver, gold, and several other metals and alloys, is one such characteristic. Copper and its alloys, in particular, have exceptional self-sanitizing effects. Silver also has this effect, and is less toxic to users than copper. Some materials, such as silver in its metallic form, may require the presence of moisture to activate the antimicrobial properties.

The present invention may be embodied in other specific forms without departing from the essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A safety device, comprising:
a belt having a fastener at a first end and an anchoring element at a second end and comprising a tensioner, a retractor, and a reel along the belt; and
wherein the fastener is attached to a load or to a coupling attached to the load to secure the load.

2. The safety device of claim 1, further comprising protective housing containing the reel.

3. The safety device of claim 1, wherein the tensioner uses a centrifugal clutch or a pendulum lock mechanism.

4. The safety device of claim 1, wherein the retractor uses a spring retractor mechanism.

5. The safety device of claim 1, wherein the fastener is a clip, hook, or button loop.

6. The safety device of claim 1, further comprising a protective shroud.

7. The safety device of claim 1, further comprising an adaptor that creates a rotating or articulating connection between the belt and the anchoring element or the fastener.

8. The safety device of claim 1, wherein the retractor applies a constant force to wind the belt on the reel.

9. The safety device of claim 1, wherein the tensioner may lock the reel to fix an extended length of the belt.

10. The safety device of claim 1, wherein the anchoring element is attached to part of a vehicle, like a vehicle seat belt receiver.

11. The safety device of claim 1, wherein the belt, the tensioner, the retractor, the reel, the fastener, or the anchoring element is comprised of polyester, nylon, plastic, acrylic, polycarbonate, steel, aluminum, brass, copper, silver, gold, fiberglass, carbon fiber, or any combination thereof.

12. The safety device of claim 1, wherein the belt, the tensioner, the retractor, the reel, the fastener, or the anchoring element is comprised of material with antibacterial, biocidal, microbicidal, antifungal, antiviral, or other antimicrobial or antipathogenic properties.

13. The safety device of claim 1, further comprising a protective coating, lining, or insulation.

14. The safety device of claim 1, wherein the load is an animal.

15. The safety device of claim 14, wherein the fastener attaches to a collar, harness, jacket, sweater, or other article of clothing or accessory affixed to the animal.

16. A method for securing a load using a belt with a fastener at a first end of the belt and an anchoring element at a second end of the belt and comprising a tensioner, a retractor, and a reel along the belt, comprising the steps of:
attaching the fastener to the load or a coupling attached to the load; and
positioning the anchoring element such that the load cannot move away from the anchoring element to a distance greater than the length of the belt.

17. The method of claim 16, further comprising the retractor applying a force to wind the belt on the reel.

18. The method of claim 17, further comprising adjusting the force to be stronger or weaker to complement the load.

19. The method of claim 16, further comprising the tensioner locking the reel to fix an extended length of the belt.

20. The method of claim 19, wherein the tensioner locks the reel in response to a trigger.
